(19) United States
(12) Patent Application Publication
(10) Pub. No.: US 2022/0414170 A1
(43) Pub. Date: Dec. 29, 2022

(54) SEARCH ENGINE WITH EFFICIENT CONTENT REFIND AND DISCOVERY

(71) Applicant: MICROSOFT TECHNOLOGY LICENSING, LLC, Redmond, WA (US)

(72) Inventors: Torbjørn HELVIK, Oslo (NO); Natalia AN, Oslo (NO); Vegar S. WANG, Tromsø (NO)

(21) Appl. No.: 17/358,796

(22) Filed: Jun. 25, 2021

(51) Int. Cl. G06F 16/9535; G06F 16/9538

(52) U.S. Cl. CPC G06F 16/9535; G06F 16/9538

(57) ABSTRACT

Aspects of the technology described herein leverage usage data of content items to facilitate returning search results relevant to a user's intent. A search engine enables a user to select from one of three filter options: a first filter option for the user's own content items, a second filter option for content items previously accessed by the user, and a third filter option for content items new to the user. In response to selection of one of the filter options, the search engine identifies and returns search results based at least in part on correspondence between usage data for content items and the selected filter option. In some aspects, the search engine may automatically select one of the filter options based on search context and provide the selected filter option as a filter suggestion.

### BACKGROUND

Search engines facilitate users in quickly finding content items, such as electronic documents (e.g., from productivity applications), web pages, messages, contact information, and the like. Search engines receive user queries from users and provide search results for content items that are responsive to the user queries. For a given user query, a search engine can process the user query, user data, contextual data, and other inputs to identify the most relevant content items for the particular user query. Search results for identified content items can be presented on a user device in several different forms on a search results user interface. The search results user interface has a limited amount of screen space, especially when the search results are presented on a mobile phone or other device with a comparatively small screen. Users become frustrated when unwanted search results are presented, instead of, or even in addition to, search results sought. This often requires users to submit new search queries to the search engine in an attempt to obtain search results for content items that satisfy the users' intent.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein eliminate or reduce the need for repetitive user queries, search result selections, content item renderings, and the like by enabling a search engine to return search results based on content usage that matches a user intent for a query. Usage of content items by users is tracked, and usage data is associated with information indexed for the content items. The usage data for a content item indicates that: the content item is the user's own content; the content item has previously been accessed by the user; or the content item is new to the user. The search engine leverages the usage data when returning search results to a user query. In particular, the search engine enables a user to select from one of three filter options for a search: a first filter option for the user's own content items, a second filter option for content items previously accessed by the user; and a third filter option for content items new to the user. In response to a selection of one of the content filters, the search engine returns search results based at least in part on correspondence between usage data for content items and the selected filter option.

In some aspects, the search engine automatically selects one of the three filter options as a filter suggestion that is provided to the user. The filter suggestion is selected based on search context, which may include, for instance, the current user query, aspects of the current search session for the user, aspects of previous search sessions of the user, aspects of search sessions by other users, and/or aspects of search results returned for the current user query.

### BRIEF DESCRIPTION OF THE DRAWINGS

Aspects of the invention are described in detail below with reference to the attached drawing figures, wherein:

FIG. 1 is a block diagram of an example operating environment suitable for implementing aspects of the technology;

FIG. 2 is a diagram showing a search system, according to an aspect of the technology described herein;

FIG. 3 is a diagram showing a search user interface providing filter options to filter search results based on usage data, according to an aspect of the technology described herein;

FIG. 4 is a diagram showing a search result user interface providing filter options to filter search results based on usage data, according to an aspect of the technology described herein;

FIG. 5 is a diagram showing a search user interface with a filter suggestion to filter search results based on usage data, according to an aspect of the technology described herein;

FIG. 6 is a diagram showing a search results user interface with a filter suggestion to filter search results based on usage data, according to an aspect of the technology described herein;

FIG. 7 is a flow diagram showing a method for filtering search results based on usage data, in accordance with an aspect of the technology described herein;

FIG. 8 is a flow diagram showing a method using a filter suggestion to filter search results based on usage data, in accordance with an aspect of the technology described herein; and

FIG. 9 is a block diagram of an exemplary computing environment suitable for use in implementing an aspect of the technology.

### DETAILED DESCRIPTION

The subject matter of aspects of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

While search engines are an incredibly useful tool for locating content items, shortcomings in existing search technologies often result in the consumption of an unnecessary quantity of computing resources (e.g., I/O costs, network packet generation costs, throughput, memory consumption, etc.). When performing searches, in some instances, users may be seeking their own content items, for instance, to resume editing the content items. In other instances, users may be seeking content items they previously accessed. In still further instances, users may be seeking content items that are new to them, for instance, when the users are performing research on a topic. However, current search technologies comingle search results, requiring the users to submit different queries to find desired content items. For example, a user may issue a first query to a search engine that returns a set of search results. The user may browse the search results and select certain search results to access the corresponding content items. Selection of content items causes retrieval of the content items from various content sources. Additionally, in some cases, applications supporting those content items are launched in order to render the content items. In instances in which the user's computing device does not have an application for a requested content item, the application must be downloaded and installed. Often, the search results returned by the search engine don't satisfy the user's goal, requiring the user to spend more time on the search process by repeating the process of issuing additional queries and selecting certain search results until the user finally accesses the desired content items or, in some cases, the user gives up because the search engine was not above to return desired search results even after multiple searches.

These repetitive inputs result in increased computing resource consumption, among other things. For instance, repetitive user queries result in packet generation costs that adversely affect computer network communications. Each time a user issues a query, the contents or payload of the query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if users repetitively issue queries, it is expensive because processing queries consumes a lot of computing resources. For example, for some search engines, a query execution plan may need to be calculated each time a query is issued, which requires a search system to find the least expensive query execution plan to fully execute the query. This decreases throughput and increases network latency, and can waste valuable time.

Aspects of the technology described herein improve the functioning of the computer itself in light of these shortcomings in existing search technologies by providing a solution that enables a search engine to provide search results that match a user's intent. In particular, some aspects are directed to a search engine able to return search results based on usage of content items by a user. To facilitate this, content item usage by users is tracked, and usage data is stored that reflects this usage. The usage data associated with a content item reflects three different types of usage. A first type of usage data comprises information indicating that the content item is the user's own content. This may be based on the user having generated or modified the content item. A second type of usage data comprises information indicating that the content item has been accessed by the user. This may include, for instance, the user having viewed the content item in a corresponding application for rendering the content item. In some instances, access of a content item by a user may be based on a search result for the content item having previously been provided to the user. A third type of usage data comprises information indicating that the content item is new to the user. This may be based on the absence of the first two types of usage data.

The search engine leverages the usage data to filter search results based on the user intent of a search. In particular, the search engine enables the user to select from one of three filter options: the first filter option returning search results for the user's content items, the second filter option returning search results for content items previously accessed by the user, and the third filter option returning search results for content items new to the user. For instance, the search engine may provide user interface elements that allow a user to select one of the filter options. In response to the selection of a filter option, the search engine returns search results based on the correspondence of usage data for content items with the selected filter option. In some configurations, the filter options act as a strict filter in which only content items with usage data matching the selected filter option are identified as search results. In other configurations, the filter options are used when ranking search results—e.g., by boosting the ranking scores for content items with usage data matching a selected filter option.

In some configurations, the search engine automatically selects a filter option based on search context and provides the selected filter option as a filter suggestion to the user. The search context may be based on, for instance, the current user query entered by the user, aspects of the current search session for the user, aspects of previous search sessions of the user, aspects of search sessions by other users, and aspects of search results identified for the current user query. For example, the search engine can identify a pattern in the search context that indicates the user is likely searching for content items with particular usage data. As another example, the search results for a current user query may be heavily skewed towards a particular usage data, and the search engine may suggest a filter option to allow the user to access search results with different usage data.

Aspects of the technology described herein provide a number of improvements over existing search technologies. For instance, computing resource consumption is improved relative to existing technologies. In particular, the filter options enable the search engine to return search results that match a user intent, thereby allowing the user to more quickly access relevant search results. The search engine enables the user to quickly re-find their own content, re-find content items previously accessed, or discover content items that are new to the user based on the user's intent. This eliminates (or at least reduces) the repetitive user queries, search result selections, and rendering of content items because the search results comprise content items with usage that corresponds to what the user is seeking. Accordingly, aspects of the technology described herein decrease computing resource consumption, such as packet generation costs. For instance, a user query (e.g., an HTTP request), would only need to traverse a computer network once (or fewer times relative to existing technologies). Specifically, the contents or payload of the user query is supplemented with header information or other metadata within a packet in TCP/IP and other protocol networks once for the initial user query. Such packet for a user query is only sent over the network once or fewer times. Thus, there is no repetitive generation of metadata and continuous sending of packets over a computer network.

In like manner, aspects of the technology described herein improve storage device or disk I/O and query execution functionality, as they only need to go out to disk a single time (or fewer times) relative to existing search technologies. As described above, the inadequacy of search results from existing search technologies results in repetitive user queries, search result selections, and content item renderings. This causes multiple traversals to disk. In contrast, aspects described herein reduce storage device I/O because the user provides only minimal inputs (e.g., an initial query) and so the computing system does not have to reach out to the storage device as often to perform a read or write operation. For example, the search engine can respond with search results that satisfy the user intent from a single user query. Accordingly, there is not as much wear on components, such as a read/write head, because disk I/O is substantially reduced.

Various configurations also improve query execution resource savings. Specifically, for example, the search system calculates a query execution plan on fewer queries relative to existing search technologies. This increases throughput and decreases network latency because aspects of the technology described herein do not have to repetitively calculate query execution plans because fewer user queries need to be executed, unlike existing search technologies.

Having briefly described an overview of aspects of the technology described herein, an exemplary operating environment in which aspects of the technology described herein may be implemented is described below.

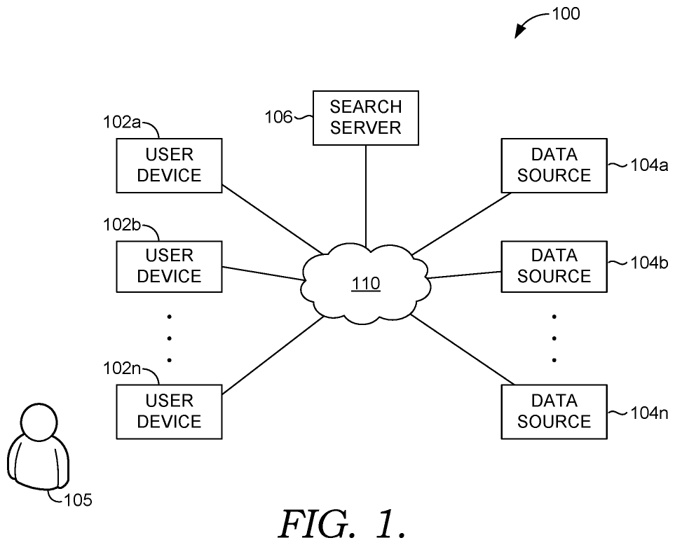

Turning now to FIG. 1, a block diagram is provided showing an operating environment 100 in which aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

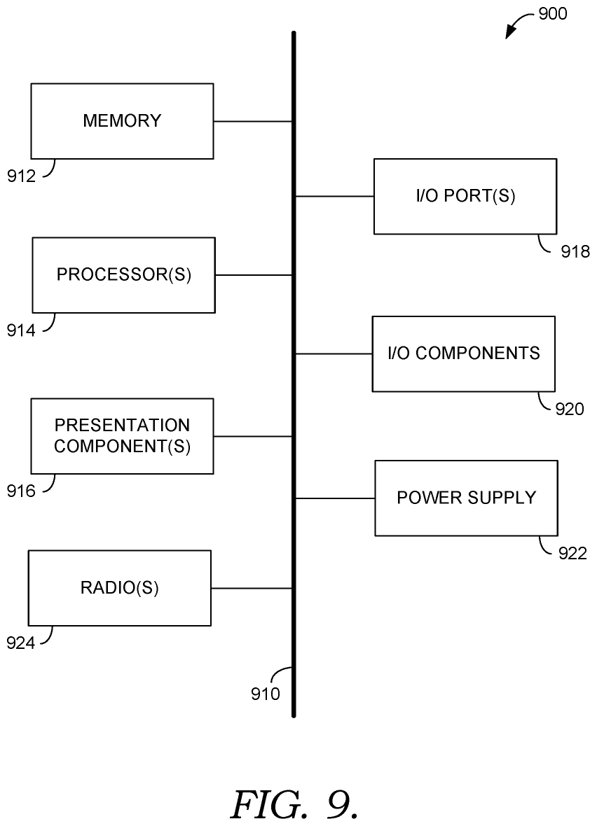

Among other components not shown, example operating environment 100 includes a number of user devices, such as user devices 102a and 102b through 102n; a number of data sources, such as data sources 104a and 104b through 104n; search server 106; and network 110. It should be understood that environment 100 shown in FIG. 1 is an example of one suitable operating environment. Each of the components shown in FIG. 1 may be implemented via any type of computing device, such as computing device 900, described below in connection to FIG. 9, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, search server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while search server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of search server 106 and user devices 102a and 102b through 102n remain as separate entities. While the operating environment 100 illustrates a configuration in a networked environment with separate user devices, servers, and data sources, it should be understood that other configurations can be employed in which components are combined. For instance, in some configurations, a user device may also serve as a data source and/or may provide search capabilities.

User devices 102a and 102b through 102n may comprise any type of computing device capable of use by a user. For example, in one aspect, user devices 102a through 102n may be the type of computing device 900 described in relation to FIG. 9 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user 105 may be associated with one or more user devices. The user 105 may communicate with search server 106, data source 104a and 104b through 104n, through the user devices.

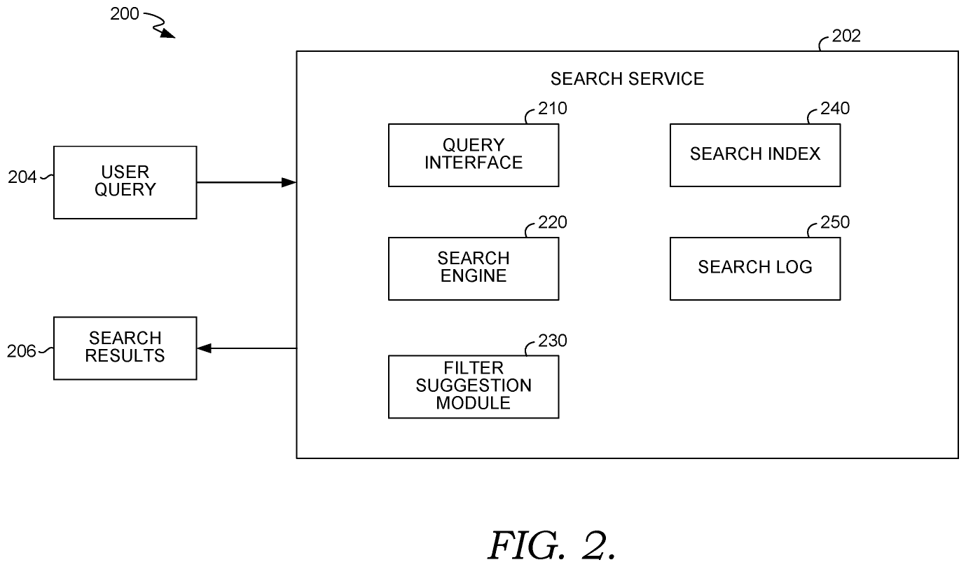

Data sources 104a and 104b through 104n may comprise data sources and/or data systems, which are configured to make data available to any of the various constituents of operating environment 100, or system 200 described in connection to FIG. 2. Data sources 104a and 104b through 104n may be discrete components separate from search server 106 or may be incorporated and/or integrated into the search server 106 or other components the operating environment 100. Among other things, the data sources 104a through 104n can store content items about which information can be indexed in a search index (not shown in FIG. 1) associated with the search server 106. Content items can comprise any type of electronic information. By way of example only and not limitation, content items can include word processing documents, spreadsheets, presentation documents, webpages, emails, calendar items, contact information, videos, and images, to name a few.

Operating environment 100 can be utilized to implement one or more of the components of system 200, described below with reference to FIG. 2, including components for receiving search queries from a user (such as the user 105), providing options to filter search results based on usage of content items by the user, and returning filtered search results in response to the search queries.

Referring now to FIG. 2, a block diagram is provided showing aspects of an example computing system architecture suitable for implementing an aspect of the technology and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

At a high level, system 200 comprises a search service 202 that receives a user query 204 and returns search results 206 identifying content items relevant to the user query 204. The search service 202 provides options for filtering content items based on usage of the content items by the user submitting the user query 204, as will be described in further detail below.

In some configurations, the search service 202 may be embodied on one or more servers, such as search server 106 of FIG. 1. In other configurations, the search service 202 may be implemented at least partially or entirely on a user device, such as user device 102a of FIG. 1. The search service 202 (and its components) may be embodied as a set of compiled computer instructions or functions, program modules, computer software services, or an arrangement of processes carried out on one or more computer systems, such as computing device 900 described in connection to FIG. 9, for example.

As shown in FIG. 2, the search service 202 includes a query interface 210, a search engine 220, a filter suggestion module 230, a search index 240, and a search log 250. In one aspect, the functions performed by components of the search service 202 are associated with one or more personal assistant applications, services, or routines. In particular, such applications, services, or routines may operate on one or more user devices (such as user device 102a), servers (such as search server 106), may be distributed across one or more user devices and servers, or be implemented in the cloud. Moreover, in some aspects, these components of the search service 202 may be distributed across a network, including one or more servers (such as server 106) and client devices (such as user device 102a), in the cloud, or may reside on a user device such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some aspects, functionality of these components can be shared or distributed across other components.

The query interface 210 receives a user query, such as the user query 204, and communicates it to other components, such as the search engine 220. The user query 204 may comprise any type of input from a user for initiating a search. For instance, the user query 204 may be a text query (e.g., a natural language query or structured query) comprising one or more keywords, an audio query comprising voice or other audio input, an image query comprising image data, or any combination thereof.

The query interface 210 may generate a graphical user interface through which the user query 204 is input, such as a search box on a web page. The query interface 210 may also comprise an Application Program Interface (API) that lets applications submit the user query 204 (and optionally other information, such as user information, contextual information, and the like) to the search service 202. The query interface 210 can also output search results, such as the search results 206. The search results may be provided, for instance, via a webpage displayed through a browser. The search results may also be provided through an application, such as a productivity application, personal assistant application, navigation application, shopping application, and the like.

The search engine 220 queries the search index 240 to identify content items relevant to the user query 204 and provides search results based on the identified content items to the query interface 210 to return as a response to the user query 204. The search index 240 stores information about content items that may be returned as search results in response to input search queries, such as the user query 204. Content items can comprise any type of electronic information. By way of example only and not limitation, content items can include word processing documents, spreadsheets, presentation documents, webpages, emails, calendar items, contact information, videos, and images, to name a few.

The search index 240 can take the form of an inverted index, but other forms are possible. The search index 240 stores the information about content items 250 in a manner that allows the search engine 220 to efficiently query the search index 240 based on the user query 204, as well as any additional information provided in conjunction with the user query 204 (e.g., identification of the user submitting the search query 204), in order to identify content items that are responsive to the user query 204. The search engine 220 can be configured to perform any number of operations on the user query 204 (e.g., stop word filtering, term stemming, query augmentation, query categorization, entity identification, etc.) and to run any number of queries on the search index 240 to identify content items.

The search index 240 also stores usage data for each content item for which information is indexed in the search index 240. The usage data for a content item generally comprises information identifying usage of the content item by one or more users. In accordance with some configurations of the technology described herein, three types of usage data are tracked for a given user and stored by the search index 240. The first type of usage data is information indicating that a content item is the user's own content item. For instance, the usage data may identify the content item as having been created (createdby:<user id>) and/or modified (modifiedby:<user id>) by the user. The second type of usage data is information indicating that a content item has been accessed by the user. In some configurations, this may include information indicating that the user has viewed the content item (viewedby:<user id>), for instance, by opening the content item in an associated application. Additionally or alternatively, this may include information indicating that a search result for the content item has previously been returned to the user in response to a search query from the user. The third type of usage data is information indicating that a content item is new to the user. In some configurations, a content item may be identified as new to the user based on the absence of usage data indicating that the content item is the user's own content item and usage data indicating that the content item has been accessed by the user. In some configurations, the search service 202 may include a system like Microsoft Office Graph to track information about content item usage by users and store the information in the search index 240.

While the search index 240 is shown as a single component in FIG. 2, it should be understood that the search index 240 can comprise any number of components storing information that may be employed to identify content items to return as search results in response to input search queries, such as the user query 204. For instance, usage data for each content item may be stored separately from information indexing keywords or other data regarding the content of each content item.

The search log 250 stores information regarding search sessions for users, including, for instance, user queries submitted by users, search results returned, and interactions with search results (e.g., hovers, click-throughs, etc.). In some embodiments, the search log 250 stores a timestamp (e.g., day, hour, minute, second, etc.) for each user query, search result, and/or user interaction with a search result.

The search service 202 leverages the usage data tracked for content items to enable users to filter search results in a manner that allows the users to access their own content items, content items they have previously accessed, or content items that are new to them. In accordance with some aspects of the technology described herein, the query interface 210 presents user-selectable user interface elements for three filter options: a first filter option for returning search results for a user's own content items, a second filter option for returning search results for content items the user has previously accessed, and a third filter option for returning search results for content items new to the user.

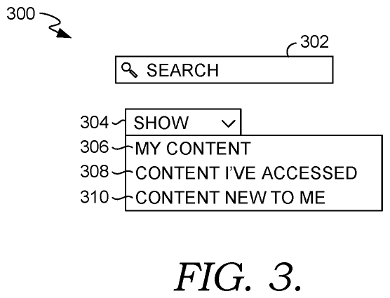

In some configurations, the query interface 210 provides the three filter options on a search user interface for initiating a search. By way of example, FIG. 3 provides a screenshot showing a search user interface 300. The search user interface 300 includes a search input box 302 that allows a user to enter a user query with one or more keywords. The search user interface 300 also includes a drop-down menu 304 with three filter options 306, 308, 310. A user can enter a user query into the search input box 302 and select one of the filter options from the drop-down menu 304 to retrieve search results for content items relevant to the user query and filtered based on the selected filter option. If the user selects the filter option 306, the search engine 220 provides search results directed to the user's own content items. If the user selects the filter option 308, the search engine 220 provides search results directed to content items that the user has previously accessed. If the user selects the filter option 310, the search engine 220 provides search results directed to content items that are new to the user.

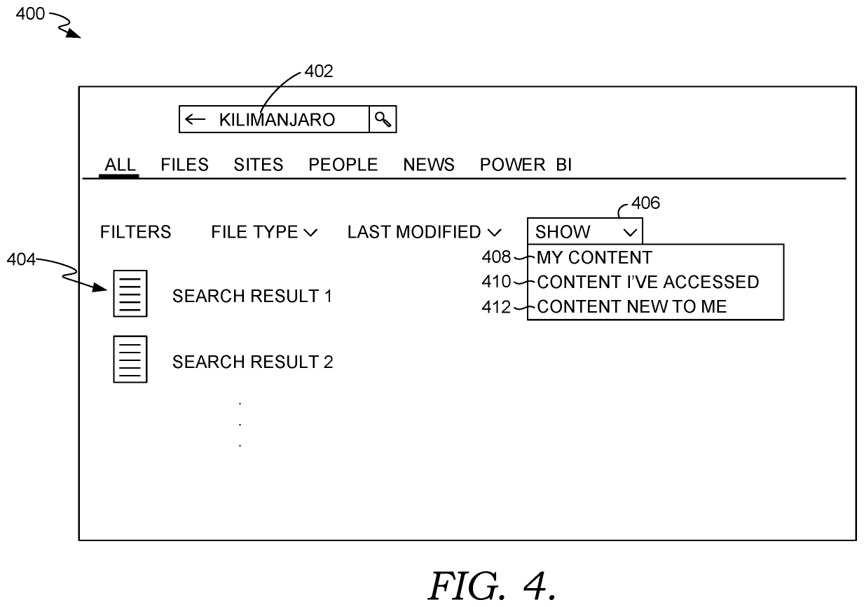

In some configurations, the query interface 210 provides the three filter options on a search result user interface that presents search results for a user query to allow a user to then filter the search results. By way of example, FIG. 4 provides a screenshot showing a search result user interface 400. The search result user interface 400 includes an indication of the user query 402 that was entered by the user and provides a list of search results 404 relevant to the user query 402. Among other things, the search result user interface 400 also includes a drop-down menu 406 with three filter options 408, 410, 412. A user can select one of the filter options from the drop-down menu 406 to cause the search engine 220 to provide search results for content items with usage data corresponding to the selected filter option. If the user selects the filter option 408, the search engine 220 provides search results for the user's own content items. If the user selects the filter option 410, the search engine 220 provides search results for content items that the user has previously accessed. If the user selects the filter option 412, the search engine 220 provides search results for content items that are new to the user. In some configurations, the selected filter option is used to filter the initial set of search results 404 to provide search results from that initial set of search results 404 that correspond to the selected filter option. In other instances, the search engine 220 performs a new query on the search index 240 based on the user query 402 and selected filter option (i.e., the search results provided after user selection of a filter option can include search results not included in the initial set of search results 404).

In further configurations, the query interface 210 can simply provide a search input box without any user interface elements for filtering based on usage data. Instead, the search service 202 may be configured to process a natural language query entered by a user to identify search keywords and a filter option specified by the user. For instance, a user could submit the user query: “show me my documents about kilimanjaro”. In that case, the search service 202 may identify “kilimanjaro” as a query keyword for identifying relevant content items, and based on the “show me my documents” portion of the user query, the search service 202 may determine to apply a filter option to identify the user's own content items. As another example, a user could submit the user query: “show me stuff about kilimanjaro I haven't seen before”. In that case, the search service 202 may again identify “kilimanjaro” as a query keyword for identifying relevant content items. Additionally, based on the “show me stuff . . . I haven't seen before” portion of the user query, the search service 202 may determine to apply a filter option to identify content items that are new to the user.

The search engine 220 leverages usage data associated with content items in the search index 240 to filter search results based on a selected filter option. In particular, the search engine 220 can query the search index 240 to identify content items that are relevant to the user query and that have usage data that corresponds to the selected filter option. In some aspects, the search engine 220 or another component of the search service 202 can augment a user query based on a selected filter option. For instance, when the user selects a filter option to return search results for the user's content items, an augmented search query can comprise: <query text> AND (createdby:<user id> OR modifiedby:<user id>). In that case, the search engine 220 identifies content items that have usage data indicating that the content items were created by and/or modified by the user. As another example, when the user selects a filter option to returns search results for content items previously accessed by the user, an augmented search query can comprise: <query text> AND viewedby:<user id>. In that case, the search engine 220 identifies content items with usage data indicating that the content items were viewed by the user. As a further example, when the user selects a filter option to return search results for content items new to the user, an augmented search query can comprise: <query text> AND NOT createdby:<user id> AND NOT modifiedby: <user id> AND NOT viewedby: <user id>. In that case, the search engine identifies content items with usage data indicating that the content items were not created, modified, or viewed by the user.

The filter suggestion module 230 uses search context to automatically select one of the three filter options as a filter suggestion for filtering a user's search. Search context can include, for instance, information regarding the current user query, information from the search log 250 (e.g., information regarding searches in the user's current search session, searches in the user's previous search sessions, searches performed by other users), and information regarding search results identified for the current user query.

In the case of search content based on the current user query and/or search log information, the filter suggestion module 230 identifies a pattern that indicates a user likely intends to obtain search results with particular usage data in order to select a filter option that likely matches the user intent for the search. For instance, when a user enters a user query into a search user interface, the filter suggestion module 230 may determine that the user has entered the exact or similar user query in previous searches and has often selected a filter option to view the user's own content items when submitting those past user queries and/or the user has typically selected search results that are the user's own content items when submitting those past user queries. In that case, the filter suggestion module 230 identifies a pattern in which the user intent is to view the user's own content items. As such, the filter suggestion module 230 selects the filter option to provide the user's own items as a filter suggestion. As another example, the filter suggestion module 230 may identify a pattern in a current search session from the user in which the user only selects search results for content items new to the user each time the user enters a new user query. Based on this pattern, the filter suggestion module 230 selects the filter option to provide content items new to the user as a filter suggestion. In some instances, the filter suggestion module 230 may identify a pattern from information regarding other users' searches in the search log 250 that matches a pattern from the user's current search session, and the filter suggestion module 230 may select a filter suggestion based on that corresponding pattern.

The search context used to select a filter option as a filter suggestion can also be based on the search results returned in response to a user query. For instance, if a majority of an initial set of search results for the user query are directed to the user's own content items, the filter suggestion module 230 can select a filter option to view content items new to the user as a filter suggestion. In this case, the filter suggestion module 230 is selecting the filter suggestion based on the distribution of the types of data usage associated with the search results. In some instances, the distribution may indicate that the initial set of search results includes content items with a certain type of usage data exceeds a threshold, indicating that a filter option associated with a different type of usage data should be selected as a filter suggestion. In other instances, the distribution may indicate that the initial set of search results includes content items with a certain type of user data below a threshold, indicating that a filter option associated with that type of usage data should be selected as a filter suggestion. It should be understood that these are provided as examples only and other approaches for selecting filter suggestions based on an initial set of search results identified for a user query may be employed.

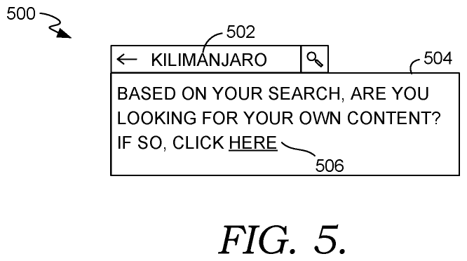

The filter suggestion module 230 communicates the filter suggestion to the query interface 210, which presents the filter suggestion with a user interface element that allows the user to select the filter suggestion. By way of example, FIG. 5 illustrates a screenshot showing a search user interface 500. As shown in FIG. 5, the user has entered a user query into the search input box 502. Based on the user query and/or other search context, the filter suggestion module 230 has selected a filter option to filter search results to the user's own content items. Based on the selected filter option, the search user interface 502 includes a filter suggestion 504 asking the user whether the user would like to have search results directed to the user's own content items. The filter suggestion 504 also includes a user interface element 506. If the user interface element 506 is selected by the user, the search engine 220 queries the search index 240 to identify search results for content items relevant to the user query that have usage data indicating the content items are the user's own content.

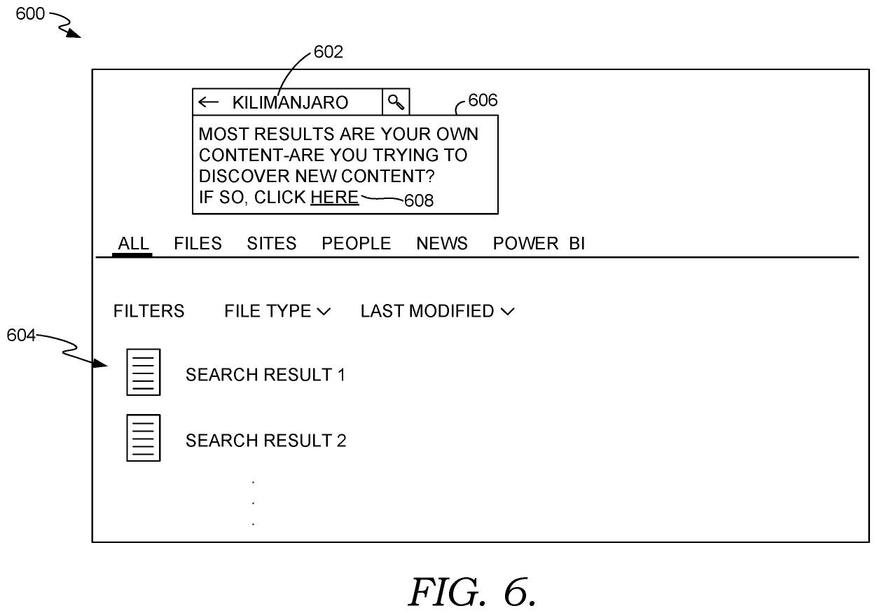

As another example, FIG. 6 illustrates a screenshot showing a search results user interface 600. As shown in FIG. 6, the search results user interface 600 provides a set of search results 604 returned in response to a user query 602 submitted by a user. In this example, the filter suggestion module 230 has selected a filter option for content items new to the user as a filter suggestion based on a distribution of the types of data usage associated with search results—i.e., a threshold of the search results in the initial set of search results 604 comprises the user's own content items. As such, the user interface 600 includes a filter suggestion 606 indicating that most of the search results are for the user's own content items and asking the user whether the user would like to have search results directed to content items new to the user. The filter suggestion 606 also includes a user interface element 608. If the user interface element 608 is selected by the user, the search engine 220 provides search results for content items relevant to the user query that have usage data indicating the content items are new to the user. In some cases, the initial set of search results 604 are filtered to provide search results for content items new to the user; while in other cases, a new query is performed on the search index 240 to return search results for content items new to the user (including search results not included in the initial set of search results 604).

While the search service 202 has been described in the context of using usage data for a single user to filter search results returned to the user, in some aspects of the technology discussed herein, usage data for a group of users may be used. For instance, the user performing a search using the search service 202 may belong to a group of users, such as a social network or team. Other approaches for grouping users may be employed. In some configurations, the search service 202 provides filter options that allow the user to filter based on usage data for a selected group of users. For instance, a first filter option returns search results for content items of any user in the selected group of users (e.g., content items created or modified by any user in the user group). A second filter option returns search results for content items previously accessed by any user in the selected group of users (e.g., content items viewed by any user in the user group and/or content items for which search results have previously been provided to any user in the user group). A third filter option returns search results for content items new to the selected group of users (e.g., content items that have not been created, modified, or viewed by any user in the user group). Any combination of these group filter options may be employed with personal filter options. For instance, in some configurations, four filter options may be provided, a first filter option to return search results for the user's own content items, a second filter option to return search results for content items previously accessed by the user, a third filter option to return search results for content items new to the user, and a fourth filter option to return search results for content items of any user in a particular group. Any and all such combinations and alternatives are contemplated to be within the scope of the technology described herein.

Further, while the search service 202 has been described as only returning search results for content items with usage data corresponding to a selected filter, in some aspects, the search service 202 may instead employ usage data corresponding with a selected filter to rank search results. In other words, in some configurations, the filter options operate as a strict filter in which search results for content items that do not have usage data corresponding with a selected filter option are not returned. In other configurations, the filter options do not operate as a strict filter, but instead are used when ranking search results such that search results for content items with usage data corresponding to a selected filter option would have ranking scores boosted. In that case, the set of search results returned to the user may include some search results for content items that do not have usage data corresponding to the selected filter option.

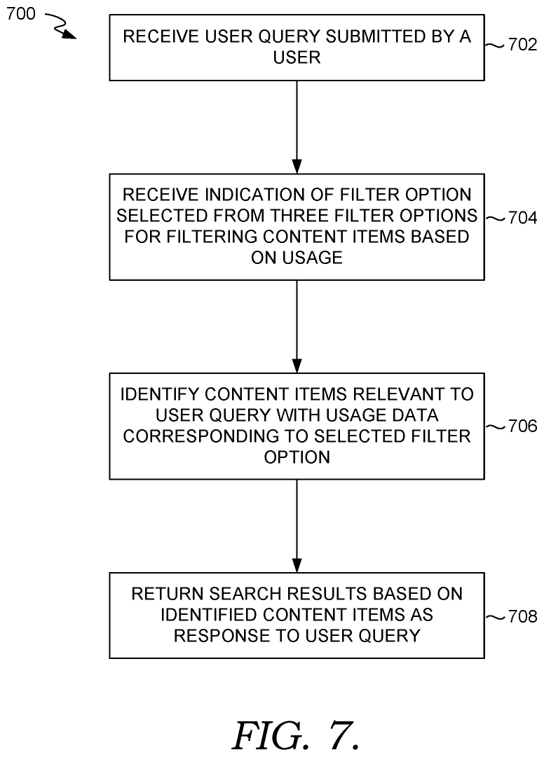

With reference now to FIG. 7, a flow diagram is provided that illustrates a method 700 for employing filter options to filter search results based on usage data. The method 700 may be performed, for instance, by the search service 202 of FIG. 2. Each block of the method 700 and any other methods or processes described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, a user query is received from a user. The user query may comprise any type of input from a user for initiating a search. For instance, the user query may be a text query (e.g., a natural language query or structured query) comprising one or more keywords, an audio query comprising voice or other audio input, an image query comprising image data, and any combination thereof. The user query may be received via a search interface, such as a search box on a web page or an application.

An indication of a filter option for filtering search results based on usage data associated with content items is received, as shown at block 704. The filter option is selected from one of three filter options for filtering search results based on usage data. The first filter option identifies content items that are the user's own content items. This may include, for instance, content items created and/or modified by the user. The second filter option identifies content items that have been accessed by the user. This may include content items that have been viewed by the user, for instance, in an application that enables viewing and/or modifying the content items. Alternatively or additionally, this may include content items that have been identified as search results in a previous search by the user. The third filter option identifies content items that are new to the user. This may include, for instance, content items that have not been created, modified, or accessed by the user.

In some configurations, user interface elements may be presented on a user interface that allows a user to select a particular filter option from the three filter options. For instance, user interface elements may be provided on a search user interface in which the user query is entered, such as the user interface elements 306, 308, 310 on the search user interface 300 of FIG. 3. In other instances, user interface elements may be provided on a search results user interface providing search results for a user query, such as the user interface elements 408, 410, 412 on the search results user interface 400 of FIG. 4. In other configurations, the selected filter options may be determined from a natural language query submitted by the user. For instance, the user query “show me my stuff on kilimanjaro” may cause selection of the filter option for the user's own content items.

Content items that are relevant to the user query and that have usage data corresponding to the selected filter option are identified, as shown at block 706. In some configurations, the selected filter option acts as strict filter such only content items that have usage data corresponding to the selected filter options are identified. In other configurations, the selected filter option is used as part of the ranking process for content items, for instance, by determining the ranking score for each content item based in part on whether the content item's usage data corresponds with the selected filter option. Search results based on the content items identified at block 706 are returned as a response to the user query, as shown at block 708.

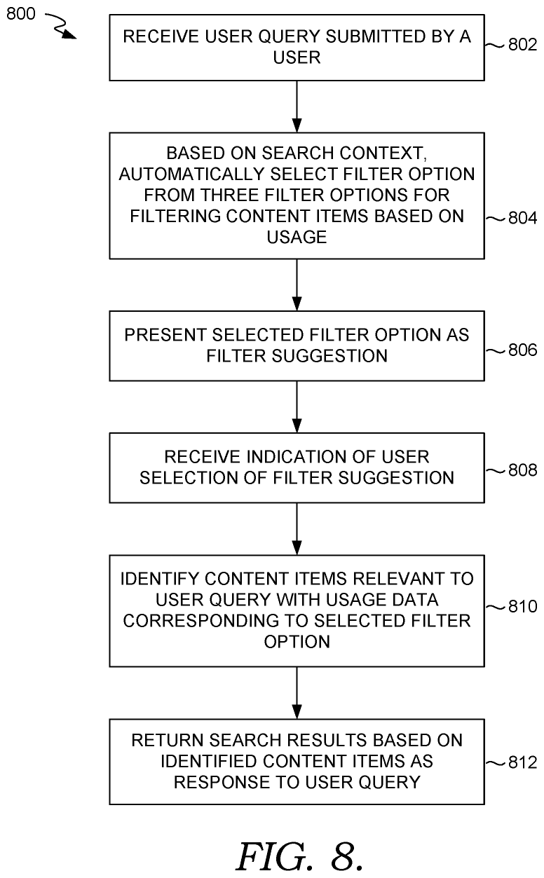

FIG. 8 is a flow diagram showing a method 800 for using a filter suggestion to filter search results based on usage data. The method 800 may be performed, for instance, by the search service 202 of FIG. 2. As shown at block 802, a user query is received from a user. The user query may comprise any type of input from a user for initiating a search. For instance, the user query may be a text query (e.g., a natural language query or structured query) comprising one or more keywords, an audio query comprising voice or other audio input, an image query comprising image data, and any combination thereof. The user query may be received via a search interface, such as a search box on a web page or an application.

A filter option for filtering search results based on usage data associated with content items is automatically selected as a filter suggestion based on search context, as shown at block 804. The filter option is selected from one of three filter options for filtering search results based on usage data. The first filter option identifies content items that are the user's own content items. This may include, for instance, content items created and/or modified by the user. The second filter options identifies content items that have been accessed by the user. This may include content items that have been viewed by the user, for instance, in an application that enable viewing and/or modifying the content. Alternatively or additionally, this may include content items that have been identified as search results in a previous search by the user. The third filter option identifies content items that are new to the user. This may include, for instance, content items that have not been created, modified, or accessed by the user.

As discussed above with reference to FIG. 2, the search context that can be used to select a filter suggestion can include, for instance, information regarding the current user query, information from a search log (e.g., information regarding searches in the user's current search session, searches in the user's previous search sessions, searches performed by other users), and information regarding search results identified for the current user query. In some cases, a filter suggestion may be selected based on identifying a pattern from the current and/or previous search sessions indicating a user intent to access certain content items (such as the user's own content item or content items new to user). In other instances, a filter suggestion may be selected based on a distribution of content items with a certain type of usage data. For instance, if a threshold percentage of the search results are for the user's own content items, it may be possible that the user is actually searching for new content items, which will be hard to find in search results that are mostly the user's own content items.

The selected filter option is presented on a user interface as a filter suggestion, as shown at block 806. The filter option may provide a reason for providing the filter suggestion and include a user interface element allowing a user to select to apply the filter option of the filter suggestion. In some instances, the filter suggestion may be presented on a search user interface in which the user query is entered, such as the filter suggestion 504 on the search user interface 500 of FIG. 5. In other instances, the filter suggestion may be provided on a search results user interface providing search results for a user query, such as the filter suggestion 606 on the search results user interface 600 of FIG. 6.

An indication of a user selection of the filter suggestion is received, as shown at block 808. For instance, the user may employ a mouse, touch input, or other input mechanism to select a user interface element of the filter suggestion. Content items that are relevant to the user query and that have usage data corresponding to the selected filter option are identified, as shown at block 810. In some configurations, the selected filter option acts as strict filter such that only content items that have usage data corresponding to the selected filter options are identified. In other configurations, the selected filter option is used as part of the ranking process for content items, for instance, by determining the ranking score for each content item based in part on whether the content item's usage data corresponds with the selected filter option. Search results based on the content items identified at block 810 are returned as a response to the user query, as shown at block 812.

With reference to FIG. 9, computing device 900 includes a bus 910 that directly or indirectly couples the following devices: memory 912, one or more processors 914, one or more presentation components 916, one or more input/output (I/O) ports 918, one or more I/O components 920, and an illustrative power supply 922. Bus 910 represents what may be one or more busses (such as an address bus, data bus, or combination thereof). Although the various blocks of FIG. 9 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 9 is merely illustrative of an exemplary computing device that can be used in connection with one or more aspects of the present technology. Distinction is not made between such categories as “workstation,” “server,” “laptop,” “handheld device,” etc., as all are contemplated within the scope of FIG. 9 and with reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer-storage media and communication media.

Computer-storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 900. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. The memory may be removable, non-removable, or a combination thereof. Exemplary hardware devices include solid-state memory, hard drives, optical-disc drives, etc. Computing device 900 includes one or more processors 914 that read data from various entities such as memory 912 or I/O components 920. Presentation component(s) 916 presents data indications to a user or other device. Exemplary presentation components include a display device, speaker, printing component, vibrating component, and the like.

The I/O ports 918 allow computing device 900 to be logically coupled to other devices, including I/O components 920, some of which may be built in. Illustrative components include a microphone, joystick, game pad, satellite dish, scanner, printer, wireless device, etc.

The I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

Some aspects of computing device 900 may include one or more radio(s) 924 (or similar wireless communication components). The radio 924 transmits and receives radio or wireless communications. The computing device 900 may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

### EMBODIMENTS

Embodiment 1. A computer-implemented method for returning search results to a user query based on usage data. The method comprises receiving, at a search engine, a user query from a user. The method also comprises receiving an indication of a selected filter option, the selected filter option being selected from three filter options comprising a first filter option identifying content items of the user, a second filter option identifying content items previously accessed by the user, and a third filter option identifying content items new to the user. The method further comprises identifying, from a search index, content items relevant to the user query and that have associated usage data corresponding to the selected filter option. The method still further comprises providing, for presentation, search results based on the identified content items.

The technology described in embodiment 1 employs filter options based on content usage that enable a search engine to return search results for content items with usage data that match a user intent for a search. This eliminates or reduces the need for repetitive user queries, search result selections, content item renderings, and the like relative to existing search technologies. Accordingly, unlike existing search technologies, there are relatively lower packet generation costs across one or more computer networks. Additionally, there are relatively lower I/O costs since query execution plans are generated for fewer user queries and/or a read/write head reaches out to storage fewer times.

Embodiment 2. The computer-implemented method of embodiment 1, wherein content items of the user comprise content items previously created by the user and/or modified by the user.

Embodiment 3. The computer-implemented method of embodiment 1, wherein content items previously accessed by the user comprise content items previously viewed by the user or content items for which a search result has previously been provided to the user.

Embodiment 4. The computer-implemented method of embodiment 1, wherein content items new to the user comprise content items that have not been created, modified, or accessed by the user.

Embodiment 5. The computer-implemented method of embodiment 1, wherein receiving the indication of the selected filter option comprises providing a search user interface presenting an input box for receiving the user query, the user interface also presenting user interface elements for the three filter options; and receiving input indicative of a user selection of the user interface element associated with one of the three filter options.

Embodiment 6. The computer-implemented method of embodiment 1, wherein receiving the indication of the selected filter option comprises receiving a text portion of the user query specifying the selected filter option.

Embodiment 7. The computer-implemented method of embodiment 6, wherein the user query is a natural language query that comprises a text query and the text portion specifying the selected filter option.

Embodiment 8. The computer-implemented method of embodiment 1, wherein the method further comprises providing a search results user interface with an initial set of search results for content items relevant to the user query prior to receiving the indication of the selected filter option, the search results user interface also including user interface elements for the three filter options; and wherein the indication of the selected filter option is received via input indicative of a user selection of the user interface element associated with one of the three filter options provided on the search results user interface.

Embodiment 9. The computer-implemented method of embodiment 1, wherein receiving the indication of the selected filter option comprises: identifying, from the search index, an initial set of content items relevant to the user query; selecting one of the three filter options based on a distribution, in the initial set of content items, of: content items of the user, content items accessed by the user, and content items new to the user; providing, for presentation, the selected one of the filter options as a filter suggestion; and receiving input indicative of a user selection of the filter suggestion.

Embodiment 10. The computer-implemented method of embodiment 1, wherein receiving the indication of the selected filter option comprises: selecting one of the three filter options based on at least one selected from the following: the user query, a current query session of the user; one or more previous query sessions of the user; and one or more previous query sessions of one or more other users; providing, for presentation, the selected one of the filter options as a filter suggestion; and receiving input indicative of a user selection of the filter suggestion.

Embodiment 11. One or more computer storage media that, when executed by a computing device, causes the computing device to perform operations. The operations comprise receiving, at a search engine, a user query from a user. The operations also comprise automatically selecting a filter option based on a search context, the selected filter option being selected from three filter options comprising a first filter option identifying content items of the user, a second filter option identifying content items previously accessed by the user, and a third filter option identifying content items new to the user. The operations further comprise providing, for presentation, the selected filter option as a filter suggestion. The operations also comprise receiving input indicative of a user selection of the filter suggestion. The operations further comprise identifying content items relevant to the user query and that have associated usage data corresponding to the selected filter option. The operations still further includes providing, for presentation, search results based on the identified content items.

The technology described in embodiment 11 employs filter options based on content usage that enable a search engine to return search results for content items with usage data that match a user intent for a search. This eliminates or reduces the need for repetitive user queries, search result selections, content item renderings, and the like relative to existing search technologies. Accordingly, unlike existing search technologies, there are relatively lower packet generation costs across one or more computer networks. Additionally, there are relatively lower I/O costs since query execution plans are generated for fewer user queries and/or a read/write head reaches out to storage fewer times.

Embodiment 12. The computer storage media of embodiment 11, wherein the search context comprises one or more selected from the following: the user query, information regarding a current search session of the user, information regarding past search sessions of the user, information regarding search sessions of one or more other users, and information regarding content items identified from a search index as relevant to the user query.

Embodiment 13. The computer storage media of embodiment 11, wherein automatically selecting a filter option based on a search context comprises: identifying a pattern based on at least one selected from the following: the user query, information regarding a current search session for user, information regarding past search sessions for the user, information regarding search sessions of one or more other users; and determining the selected filter option based on the pattern.

Embodiment 14. The computer storage media of embodiment 11, wherein automatically selecting a filter option based on a search context comprises identifying, from a search index, an initial set of content items relevant to the user query; and determining the selected filter option based on a distribution, in the initial set of content items, of: content items of the user, content items accessed by the user, and content items new to the user.

Embodiment 15. The computer storage media of embodiment 14, wherein determining the selected filter option based on the distribution comprises: determining the initial set of content items includes content items corresponding with a type of data usage above a threshold; and selecting one of the three filter options that corresponds with a different type of data usage.

Embodiment 16. The computer storage media of embodiment 14, wherein determining the selected filter option based on the distribution comprises: determining the initial set of content items includes content items corresponding with a type of data usage below a threshold; and selecting one of the three filter options that corresponds with the type of data usage.

Embodiment 17. A computer system comprising: one or more processors; and one or more computer storage media storing computer-usable instructions that, when used by the one or more processors, cause the computer system to perform operations. The operations comprise providing a search result user interface in response to a user query from a user, the search result user interface comprising an initial set of search results for content items relevant to the user query, the search result user interface also comprising user interface elements for three filter options, the three filter options comprising a first filter option identifying content items of the user, a second filter option identifying content items previously accessed by the user, and a third filter option identifying content items new to the user. The operations also comprise in response to input indicative of a user selection of the user interface element for one of the three filter option, determining a selected filter option. The operations further comprise identifying content items relevant to the user query and that have associated usage data corresponding to the selected filter option. The operations still further comprise providing, for presentation, search results based on the identified content items.

The technology described in embodiment 17 employs filter options based on content usage that enable a search engine to return search results for content items with usage data that match a user intent for a search. This eliminates or reduces the need for repetitive user queries, search result selections, content item renderings, and the like relative to existing search technologies. Accordingly, unlike existing search technologies, there are relatively lower packet generation costs across one or more computer networks. Additionally, there are relatively lower I/O costs since query execution plans are generated for fewer user queries and/or a read/write head reaches out to storage fewer times.

Embodiment 18. The computer system of embodiment 17, wherein identifying the content items relevant to the user query and that have associated usage data corresponding to the selected filter option comprises filtering the initial set of search results to include only search results for content items with associated usage data corresponding to the selected filter option.

Embodiment 19. The computer system of embodiment 17, wherein identifying the content items relevant to the user query and that have associated usage data corresponding to the selected filter option comprises querying a search index based on the user query and the selected filter option to identify the content items relevant to the user query and that have associated usage data corresponding to the selected filter option.

Embodiment 20. The computer system of embodiment 17, wherein identifying the content items relevant to the user query and that have associated usage data corresponding to the selected filter option comprises ranking content items from a search index based on relevance to the user query and correspondence of usage data to the selected filter option.

Many different arrangements of the various components depicted, as well as components not shown, are possible without departing from the scope of the claims below. Aspects of the present technology have been described with the intent to be illustrative rather than restrictive. Alternative aspects will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computer-implemented method comprising:
receiving, at a search engine, a user query from a user;
automatically selecting a filter option based on a search context, the selected filter option being selected from three filter options comprising a first filter option identifying content items of the user, a second filter option identifying content items previously accessed by the user, and a third filter option identifying content items new to the user, wherein the search context includes information relating to search usage data;
providing, for presentation, the selected filter option as a filter suggestion;
receiving input indicative of a user selection of the filter suggestion as the selected filter option;
identifying, from a search index, content items relevant to the user query and that have associated usage data corresponding to the selected filter option, based on receiving the input indicative of the user selection of the filter suggestion as the selected filter option; and
providing, for presentation, search results based on the identified content items.

2. The computer-implemented method of claim 1, wherein content items of the user comprise content items previously created by the user and/or modified by the user.

3. The computer-implemented method of claim 1, wherein content items previously accessed by the user comprise content items previously viewed by the user or content items for which a search result has previously been provided to the user.

4. The computer-implemented method of claim 1, wherein content items new to the user comprise content items that have not been created, modified, or accessed by the user.

5. (canceled)

6. The computer-implemented method of claim 1, further comprising:
determining the search context based on a text portion of the user query.

7. The computer-implemented method of claim 6, wherein the user query is a natural language query that comprises a text query and the text portion specifying the selected filter option.

8. The computer-implemented method of claim 1, wherein the computer-implemented method further comprises:
providing a search results user interface with an initial set of search results for content items relevant to the user query prior to receiving input indicative of the user selection of the filter suggestion as the selected filter option.

9. (canceled)

10. (canceled)

11. One or more computer storage media that, when executed by a computing device, causes the computing device to perform operations, the operations comprising:
receiving, at a search engine, a user query from a user;
automatically selecting a filter option based on a search context, the selected filter option being selected from filter options comprising a first filter option identifying content items of the user, a second filter option identifying content items previously accessed by the user, and a third filter option identifying content items new to the user, wherein the search context includes information relating to search usage data;
providing, for presentation, the selected filter option as a filter suggestion;
receiving input indicative of a user selection of the filter suggestion;
identifying content items relevant to the user query and that have associated usage data corresponding to the selected filter option, based on receiving the input indicative of the user selection of the filter suggestion as the selected filter option; and
providing, for presentation, search results based on the identified content items.

12. The computer storage media of claim 11, wherein the search context comprises one or more selected from the following: the user query, information regarding a current search session of the user, information regarding past search sessions of the user, information regarding search sessions of one or more other users, and information regarding content items identified from a search index as relevant to the user query.

13. The computer storage media of claim 11, wherein automatically selecting a filter option based on a search context comprises:
identifying a pattern based on at least one selected from the following: the user query, information regarding a current search session for user, information regarding past search sessions for the user, information regarding search sessions of one or more other users; and
determining the selected filter option based on the pattern.

14. The computer storage media of claim 11, wherein automatically selecting a filter option based on a search context comprises:
identifying, from a search index, an initial set of content items relevant to the user query; and
determining the selected filter option based on a distribution, in the initial set of content items, of: content items of the user, content items accessed by the user, and content items new to the user.

15. The computer storage media of claim 14, wherein determining the selected filter option based on the distribution comprises:
determining the initial set of content items includes content items corresponding with a type of data usage above a threshold; and
selecting one of the filter options that corresponds with a different type of data usage.

16. The computer storage media of claim 14, wherein determining the selected filter option based on the distribution comprises:
determining the initial set of content items includes content items corresponding with a type of data usage below a threshold; and
selecting one of the filter options that corresponds with the type of data usage.

17. A computer system comprising:
one or more processors; and
one or more computer storage media storing computer-usable instructions that, when used by the one or more processors, cause the computer system to perform operations comprising:
providing a search result user interface in response to a user query from a user,
automatically selecting a filter option based on a search context, the selected filter option being selected from filter options comprising a first filter option identifying content items of the user, a second filter option identifying content items previously accessed by the user, and a third filter option identifying content items new to the user, wherein the search context includes information relating to search usage data,
providing, for presentation, the selected filter option as a filter suggestion,
receiving input indicative of a user selection of the filter suggestion as the selected filter option,
in response to receipt of the input indicative of a user selection of the selected filter option,
identifying content items relevant to the user query and that have associated usage data corresponding to the selected filter option, and
providing, for presentation, search results based on the identified content items.

18. The computer system of claim 17, wherein identifying the content items relevant to the user query and that have associated usage data corresponding to the selected filter option comprises:
receiving an initial set of search results based on the query; and
filtering the initial set of search results to include only search results for content items with associated usage data corresponding to the selected filter option.

19. The computer system of claim 17, wherein identifying the content items relevant to the user query and that have associated usage data corresponding to the selected filter option comprises:
querying a search index based on the user query and the selected filter option to identify the content items relevant to the user query and that have associated usage data corresponding to the selected filter option.

20. The computer system of claim 17, wherein identifying the content items relevant to the user query and that have associated usage data corresponding to the selected filter option comprises ranking content items from a search index based on relevance to the user query and correspondence of usage data to the selected filter option.
